(19) United States
(12) Patent Application Publication
(10) Pub. No.: US 2008/0136288 A1
(43) Pub. Date: Jun. 12, 2008

(54) Commutator and Method of Commutating Current in a Rotating Electrical Machine

(75) Inventors: Thomas Mahon Shaw, London (GB); Tony Muldowney-Colston, London (GB); Jonathan James Bremner, West Sussex (GB); David John Tompkins, Surrey (GB); Suleiman Abu Sharkh, Southampton (GB)

Correspondence Address: LEYDIG VOIT & MAYER, LTD, 700 THIRTEENTH ST. NW, SUITE 300, WASHINGTON, DC, 20005-3960, US

(73) Assignee: DOLPHIN ELECTRIC HOLDINGS INC., Hong Kong (CN)

(21) Appl. No.: 11/573,130

(22) PCT Filed: Aug. 2, 2005
(86) PCT No.: PCT/IB2005/002278

§ 371 Date: Dec. 20, 2007

(30) Foreign Application Priority Data
Aug. 2, 2004 (GB) 0417188.0
Dec. 17, 2004 (GB) 0427645.7
Feb. 10, 2005 (GB) 0502657.0

(51) Int. Cl. H01R 39/04; H02K 13/14

(52) U.S. Cl. 310/233

(57) ABSTRACT

A commutator for rotation with or by the shaft of a electrical machine has first and second electrically conductive commutator segments provided on a base for electrical engagement with brushes connected to windings. Isolated from and interspersed between the commutator segments are first and second freewheeling segments. A first diode is connected between the first commutator segment and the first freewheeling segment. A second diode is connected between the second commutator segment and the second freewheeling segment. The diodes allow current to flow in only one direction between the commutator and freewheeling segments to help suppress commutation sparking.

The present invention relates to commutators, that is to say mechanisms by which the direction of an electric current flowing through a winding of a rotating electrical machine is reversed back and forth, and to a method of commutating current in a rotating electrical machine.

Direct current (DC) electrical machines will act as either a motor or a generator. If a DC current is input to the stator or field windings the machine acts as a motor. If mechanical power is applied to rotate the machine shaft it will act as a generator. The following discussion relates to an electric motor, but the invention also applies to generators.

Multiphase permanent-magnet (PM) brushless motors are extremely versatile and efficient machines offering superior control and efficiency compared with AC synchronous and PM DC motors in many different applications. In some cases, however, end users require the compactness, high efficiency and long life of a brushless motor but without the level of controllability offered with brushless motors. Too often the significant cost of the drive and position sensing electronics required to operate the brushless motor, regardless of the level of control required, forces end users to settle for an inferior class of motor.

The ability to use a simple, inexpensive mechanical commutation arrangement for supplying current to the stator or field windings of a PM motor in place of expensive drive electronics may allow end users to specify a multiphase PM motor in low control, cost sensitive applications.

Wound rotor or armature DC “commutator” motors are often used in cases where smooth torque and simple voltage control are prerequisites. However, when the brushes require replacement the motor has to be disassembled which takes significant time. Furthermore, a wound rotor restricts the minimum rotor diameter that is practical to manufacture. A wound rotor also leads to inferior copper slot fill compared with brushless and asynchronous motors. Low inertia rotors are difficult to achieve because the large number of commutator segments needed to achieve smooth torque can lead to increased sparking which accelerates brush wear and produces high frequency RF noise.

It is an object of the present invention to provide a commutator and method of commutating current in a rotating electrical machine that overcomes or ameliorates the above problems, or at least provides the public with a useful alternative.

According to a first aspect of the invention there is provided a commutator device for rotation with or by the shaft of a rotating electrical machine and allowing current from an electrical supply through a winding of the machine, including:

first and second electrically conductive commutator segments for electrical engagement with brushes connected to windings,

first and second freewheeling segments electrically isolated from the first and second commutator segments and interspersed at respective positions between the first and second commutator segments, and

a first diode connected between the first commutator segment and the first freewheeling segment for allowing current flow only from the first commutator segment to the first freewheeling segment, and a second diode connected between the second commutator segment and the second freewheeling segment for allowing current flow only from the second freewheeling segment to the second commutator segment.

According to a second aspect of the invention there is provided a commutator for rotation with or by the shaft of a rotating electrical machine and allowing current to flow from an electrical supply through a winding of the machine, including:

a positive slip-ring and a negative slip-ring each having a continuous conducting circular perimeter,

a positive electrically conductive commutator segment electrically connected to the positive slip-ring and a negative electrically conductive commutator segment electrically connected to the negative slip-ring, and

first and second freewheeling segments electrically isolated from the commutator segments and interspersed at respective positions between the commutator segments, and

a first diode between the negative commutator segment and the first freewheeling segment for allowing current flow only from the negative commutator segment to the first freewheeling segment, and a second diode between the positive commutator segment and the second freewheeling segment for allowing current flow only from the second freewheeling segment to the positive commutator segment.

Preferably, the commutator further includes three brushes spatially located 120 degrees apart about the commutator and connected to windings of a motor, wherein during rotation of the commutator the commutator segments and freewheeling segments alternately engage with the three brushes connected to the windings.

Preferably, the windings are connected to the brushes in a delta configuration.

Preferably, the windings are connected to the brushes in a star configuration.

Preferably, wherein at any instantaneous rotational position of the base two of the brushes are in electrical contact with two of the freewheeling segments.

Preferably, wherein the commutator segments and freewheeling segments have respective graphite shells for engagement with the brushes.

According to a third aspect of the invention there is provided a method of commutating current in a rotating electric machine having windings arranged to engage a rotational commutator includes providing diodes in the commutator that are connected between the windings and the positive & negative supply during commutation of current in the windings.

Further aspects of the invention will become apparent from the following description which is given by way of example only.

Embodiments of the invention will now be described by way of example only and with reference to the accompanying drawings in which:

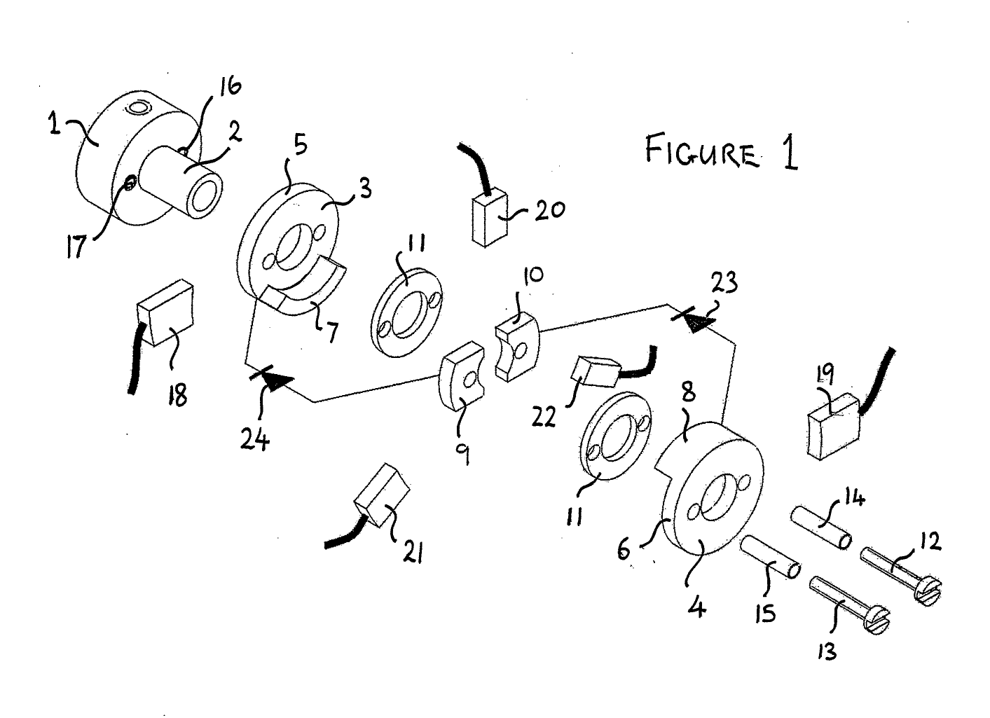

FIG. 1 is an exploded view of a commutator according to the invention,

FIG. 2 is an exploded view of an alternative embodiment of a commutator according to the invention, and

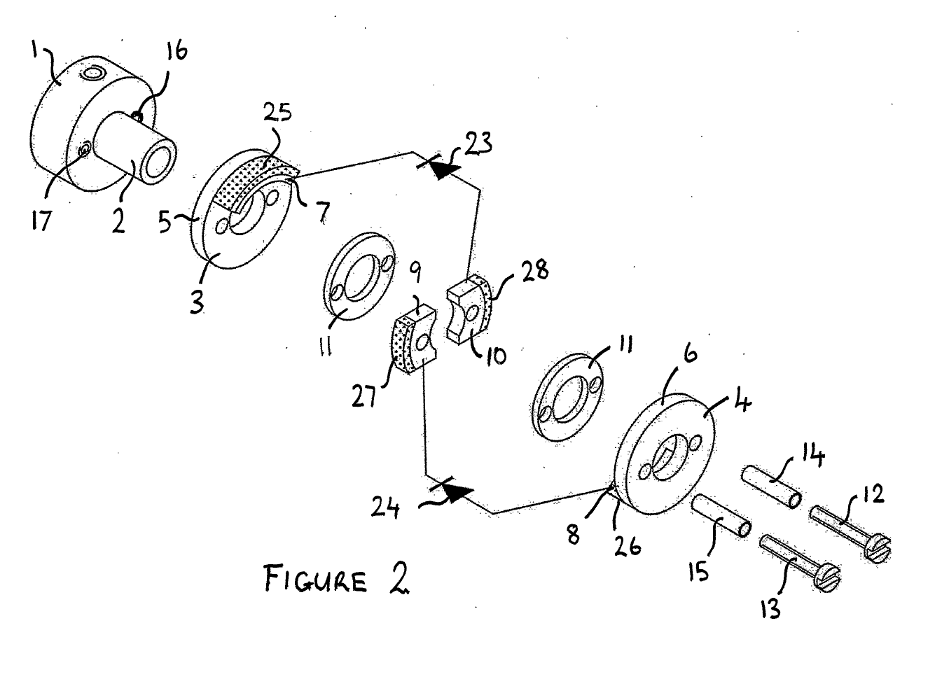

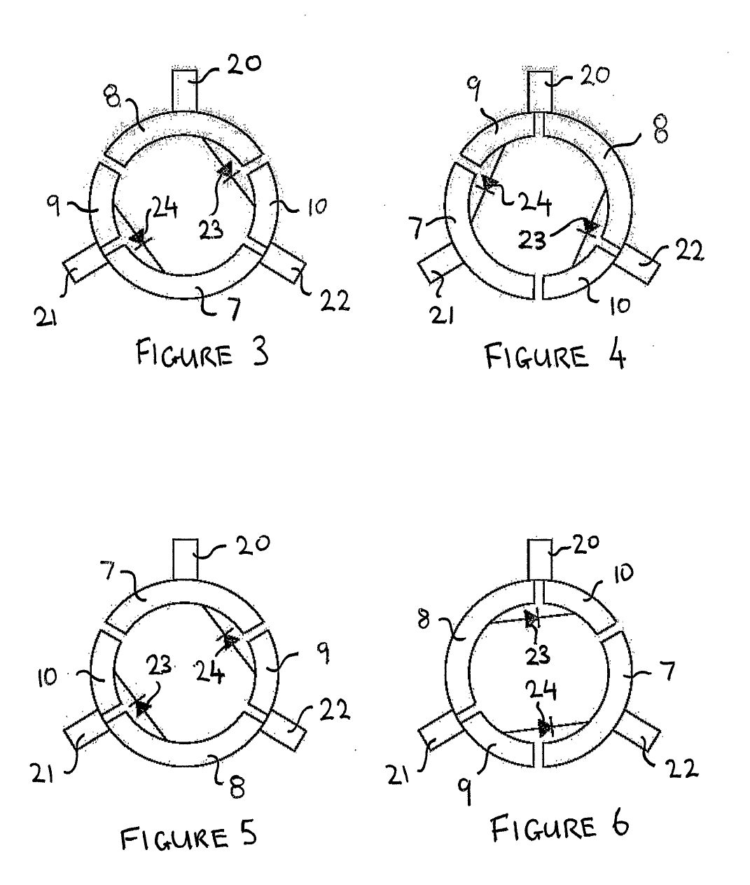

FIGS. 3-6 illustrate of the operation of the commutator.

In FIG. 1 there is depicted a commutator consisting of a circular moulded base 1 with central hub 2 for supporting commutator components. Mounted on the hub 2 are first and second complementarily opposed commutator elements each comprising a ring shaped plate 3, 4 having a continuous conducting circular periphery 5, 6 respectively. A conductive commutation segment 7, 8 projects axially from adjacent each periphery 5, 6. On the hub 2 interspersed between the commutation segments 7, 8 are two freewheeling segments 9, 10. The commutation elements and freewheel segments 9, 10 are separated by insulation rings 11. The commutator components are fixed to the hub 2 by two fixing screws 12, 13 the secure within threaded bores 16, 17 in base 1. The fixing screws 12, 13 located within isolating sleeves 14, 15 to prevent short-circuit of the commutator components.

The commutator is coupled to or disposed on a motor shaft with brushes engaging the commutator surfaces to transfer electrical current between a DC supply and the motor windings. A first supply brush 18 is connected to the positive side of a DC supply and positioned in continuous contact with the conductive slip-ring surface 5 of commutator element 3. A second supply brush 19 is connected to the negative side of the DC supply and positioned in continuous contact with the conductive slip-ring surface 6 of commutator element 4. By this arrangement the first commutation segment 7 is a positive segment and the second commutation segment 8 is a negative segment.

In the case of a three phase motor three winding brushes 20, 21, and 22 are spatially located 120 mechanical degrees apart about the commutator. The phase brushes 20, 21, 22 engage alternately with the commutation and freewheeling segments in the rotational order 7, 10, 8, 9 as the commutator rotates. The conventional direction of rotation of the commutator is clockwise as viewed in the drawings.

Two diodes 23, 24 are electrically connected between the freewheeling segments 9, 10 and commutation segments 7, 8. The first diode 23 is connected for forward bias current flow from the negative commutation segment 8 to the freewheeling segment 10 that is rotationally ahead of it. The second diode 24 is connected for forward biased current flow from the other freewheeling segments 9 to the positive commutation segment 7 that rotationally follows it.

In the preferred embodiment the commutation segments 7, 8 and freewheeling segments 9, 10 have conductive graphite shells 25, 26, 27, 28 located in their outer conductive surfaces for electrical connection with winding brushes 20, 21, 22. The carbon-carbon connections between the graphite shells 25, 26, 27, 28 and brushes 20, 21, 22 reduce commutation arching at the brush faces.

The workings of the freewheeling segments 9, 10 and the diodes 23, 24 will now be explained with reference to FIGS. 3 to 6. In FIGS. 3 to 6 the positive and negative supply brushes have been omitted to simplify the 2-dimensional illustration. The arrangement illustrated is electrically entirely equivalent to that described in the commutator described above. The commutator rotates clockwise.

In FIG. 3 first winding brush 20 is fully in contact with the negative commutation segment 8. The other winding brushes 21, 22 are positional between the other commutation segment 7, and the two freewheeling segments 9, 10. It should be noted that the arc angles of the freewheeling segments 9, 10 are such that a phase brush can never bridge both commutation segments 7, 8 as this would cause a supply short-circuit.

In FIG. 4 the commutator has rotated 120 degrees clockwise until first winding brush 20 is in contact with freewheeling segment 9 and about to break contact with the negative commutation segment 8. As brush 20 breaks contact with the negative commutation segment 8 a reverse EMF is produced that forward biases the diode 24 and current is shunted via the forward biased diode 24 from freewheeling segment 9 to the second commutation segment 7. This helps suppress any voltage spike between the brush 20 and commutation segment 8.

In FIG. 5 the commutator has rotated a further 120 degrees clockwise until third winding brush 22 is in contact with freewheeling segment 9 and about to break contact with the commutation segment 8. Again, as brush 22 breaks contact with the commutation segment 8 the current is shunted via forward biased diode 24 from freewheeling segment 9 to the other commutation segment 7. This helps suppress any voltage spike between the brush 22 and commutation segment 8.

In FIG. 6 the commutator has rotated a further 120 degrees clockwise until second winding brush 21 is in contact with freewheeling segment 9 and about to break contact with the commutation segment 8. Again, as brush 21 breaks contact with the commutation segment 8 the current is shunted via forward biased diode 24 from freewheeling segment 9 to the other commutation segment 7. This helps suppress any voltage spike between the brush 21 and commutation segment 8.

Diode 23 performs the same function as diode 24, but from the positive segment to the negative supply. For example, in FIG. 3, third winding brush 22 is in contact with freewheeling segment 10 and, as the commutator rotates clockwise, is about to break contact with the positive commutation segment 7. As brush 22 breaks contact with the positive commutation segment 7 a reverse EMF is produced that forward biases the diode 23 and the current is shunted via diode 23 from negative commutation segment 8 to freewheeling segment 10 suppressing any voltage spike between the brush 22 and commutation segment 7.

The connections incorporating diodes 23, 24 between the freewheeling segments 9, 10 and the positive and negative commutator segments 7, 8 are provided such that for a given direction of rotation as a brush leaves a commutator segment and makes contact with an adjacent freewheeling segment the freewheeling segment will connect via a diode to the a commutation segment of the opposite polarity. The freewheeling segments and associated diodes prevent the build-up of large inductive voltage spikes as the phase brushes leave the commutator segments, thus eliminating the arcing normally associated with mechanically commutated machines.

Where in the foregoing description reference has been made to integers of elements having known equivalents then such are included as if individually set forth herein. Embodiments of the invention have been described, however it is understood that variations, improvement or modifications can take place. For example, in alternative embodiments other topological commentator arrangements are used. The brush assembly could be mounted inside the circumference of the commutator, rather than outside, thus reducing the overall volume of the device. Or alternatively, the whole device can be configured as a disc, with the brushes arranged perpendicular to the surface of the disc. It should also be noted that while the above description and illustration describes a 2-pole commutator a commutator of n poles where n=2, 4, 6, 8 etc. can be constructed by increasing the number of positive, negative and freewheeling segments.

1. A commutator device for rotation with or by the shaft of a rotating electrical machine and controlling current flow from an electrical supply through a winding of the machine, including:
first and second electrically conductive commutator segments for electrical engagement with brushes connected to windings,
first and second freewheeling segments electrically isolated from the first and second commutator segments and interspersed at respective positions between the first and second commutator segments, and
a first diode connected between the first commutator segment and the first freewheeling segment, allowing current flow only from the first commutator segment to the first freewheeling segment, and a second diode connected between the second commutator segment and the second freewheeling segment, allowing current flow only from the second freewheeling segment to the second commutator segment.

2. A commutator for rotation with or by the shaft of a rotating electrical machine and controlling current flow from an electrical supply through a winding of the machine, including:
a positive slip-ring and a negative slip-ring, each having a continuous conducting circular perimeter,
a positive electrically conductive commutator segment electrically connected to the positive slip-ring and a negative electrically conductive commutator segment electrically connected to the negative slip-ring,
first and second freewheeling segments electrically isolated from the commutator segments and interspersed at respective positions between the commutator segments; and
a first diode between the negative commutator segment and the first freewheeling segment, allowing current flow only from the negative commutator segment to the first freewheeling segment, and a second diode between the positive commutator segment and the second freewheeling segment, allowing current flow only from the second freewheeling segment to the positive commutator segment.

3. The commutator of claim 1 further including three brushes spatially located 120 degrees apart about the commutator and connected to windings of a motor, wherein during rotation of the commutator, the commutator segments and freewheeling segments alternately engage the three brushes connected to the windings.

4. The commutator of claim 3 wherein the windings are connected to the brushes in a delta configuration.

5. The commutator of claim 3 wherein the windings are connected to the brushes in a star configuration.

6. The commutator of claim 1 wherein, at any instantaneous rotational position, two of the brushes are in electrical contact with the first and second freewheeling segments, respectively.

7. The commutator of claim 1 wherein the commutator segments and freewheeling segments have respective graphite shells for engagement with the brushes.

8. A method of commutating current in a rotating electric machine having windings arranged to engage a rotational commutator including providing diodes in the commutator that are connected between the windings and positive and negative lines supply during commutation of current in the windings.

9. (canceled)

10. The commutator of claim 2 further including three brushes spatially located 120 degrees apart about the commutator and connected to windings of a motor, wherein during rotation of the commutator, the commutator segments and freewheeling segments alternately engage the three brushes connected to the windings.

11. The commutator of claim 10 wherein the windings are connected to the brushes in a delta configuration.

12. The commutator of claim 10 wherein the windings are connected to the brushes in a star configuration.

13. The commutator of claim 2 wherein, at any instantaneous rotational position, two of the brushes are in electrical contact with the first and second freewheeling segments, respectively.

14. The commutator of claim 2 wherein the commutator segments and freewheeling segments have respective graphite shells for engagement with the brushes.
